(19) United States
(12) Patent Application Publication
(10) Pub. No.: US 2015/0332883 A1
(43) Pub. Date: Nov. 19, 2015

(54) ELECTRICAL SWITCHING APPARATUS AND LINEAR ACTUATOR ASSEMBLY THEREFOR

(71) Applicant: EATON CORPORATION, Cleveland, OH (US)

(72) Inventor: JAMES JEFFERY BENKE, PITTSBURGH, PA (US)

(73) Assignee: EATON CORPORATION, Cleveland, OH (US)

(21) Appl. No.: 14/277,338

(22) Filed: May 14, 2014

(51) Int. Cl. H01H 71/12; H01H 3/32; H01H 51/00

(52) U.S. Cl. CPC H01H 71/125; H01H 51/00; H01H 3/32

(57) ABSTRACT

A linear actuator assembly is for an electrical switching apparatus, such as a multi-pole circuit breaker. The circuit breaker includes a plurality of pole units each having separable contacts. The linear actuator assembly includes a base unit comprising a housing, and a plurality of linear actuators. Each linear actuator is mounted within the housing in alignment with a corresponding one of the pole units. Each linear actuator actuates the separable contacts of the corresponding one of the pole units. A controller is adapted to control actuation of the linear actuators.

### BACKGROUND

1. Field

The disclosed concept relates generally to electrical switching apparatus and, more particularly, to electrical switching apparatus such as for example, circuit breakers. The disclosed concept also relates to linear actuator assemblies for circuit breakers.

2. Background Information

Electrical switching apparatus, such as circuit breakers, provide protection for electrical systems from electrical fault conditions such as, for example, current overloads, short circuits, abnormal voltage and other fault conditions. Typically, circuit breakers include an operating mechanism which opens electrical contact assemblies to interrupt the flow of current through the conductors of an electrical system in response to such fault conditions as detected, for example, by a trip unit.

FIG. 1 shows an example medium voltage circuit breaker 2, which includes a housing 4 (with the cover removed to show internal structures), separable contacts (shown in simplified form in hidden line drawing), and an operating mechanism 10 (shown in simplified form) structured to open and close the separable contacts 6. The operating mechanism 10 is generally a mechanical design, which among other components, includes a pivotable pole shaft 12 that extends between opposing sides 14,16 of the circuit breaker housing 4 and is supported by at least one pole shaft support 18. A spring-operated stored energy assembly 50 is also disposed within the housing 4. Thus, the phases (three are shown) of the circuit breaker 2 are all driven via one mechanical mechanism. Among other problems, such a design is relatively complex and, therefore, expensive. It is also subject to a limited mechanical life, and is larger and heavier than desired.

There is, therefore, room for improvement in electrical switching apparatus, such as circuit breakers, and in linear actuator assemblies therefor.

### SUMMARY

These needs and others are met by embodiments of the disclosed concept, which are directed to a linear actuator assembly for electrical switching apparatus.

As one aspect of the disclosed concept, a linear actuator assembly is provided for an electrical switching apparatus. The electrical switching apparatus comprises a plurality of pole units each including separable contacts. The linear actuator assembly comprises: a base unit comprising a housing; and a plurality of linear actuators each being structured to be mounted within the housing in alignment with a corresponding one of the pole units. Each of the linear actuators is structured to actuate the separable contacts of the corresponding one of the pole units.

The base unit may further comprise a controller adapted to control actuation of the linear actuators. The base unit may further comprise a plurality of sensors in electrical communication with the controller wherein, responsive to detection of a predetermined electrical condition by a corresponding one of the sensors, the controller actuates at least one of the linear actuators. The controller may be adapted to synchronize the simultaneous actuation of all of the linear actuators.

The base unit may further comprise a pole shaft assembly including a pole shaft, a mounting bracket, and an interlock assembly. The mounting bracket may movably couple the pole shaft to the housing. The interlock assembly may be structured to interlock the pole shaft with the plurality of linear actuators, thereby synchronizing actuation of the linear actuators.

As another aspect of the disclosed concept, an electrical switching apparatus comprises: a plurality of pole units each including separable contacts; and a linear actuator assembly comprising: a base unit comprising a housing, and a plurality of linear actuators each being mounted within the housing in alignment with a corresponding one of the pole units. Each of the linear actuators is structured to actuate the separable contacts of the corresponding one of the pole units.

The electrical switching apparatus may be a three pole circuit breaker. The housing may include an exterior and an interior. The plurality of pole units may be three encapsulated pole units mounted on the exterior, and the plurality of linear actuators may be three magnetic linear actuators mounted in the interior.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a prior art circuit breaker and mechanical actuator assembly therefor;

FIG. 2A is an isometric view of a circuit breaker in accordance with an embodiment of the disclosed concept;

FIG. 2B is an isometric view of the opposite side of the circuit breaker of FIG. 2A;

FIG. 3A is an isometric view of the circuit breaker of FIG. 2A, shown with the housing removed to show internal structures, including a linear actuator assembly in accordance with an embodiment of the disclosed concept;

FIG. 3B is an isometric view of the opposite side of the circuit breaker and linear actuator therefor of FIG. 3A;

FIG. 4A is an isometric view of a circuit breaker and linear actuator assembly therefor, in accordance with another embodiment of the disclosed concept;

FIG. 4B is an isometric view of the opposite side of the circuit breaker and linear actuator therefor of FIG. 4A;

FIG. 5 is an enlarged isometric view of a portion of the linear actuator assembly of FIG. 4B;

FIG. 6 is a side elevation view of the portion of the linear actuator assembly of FIG. 5;

FIG. 7 is an isometric view of a portion of the circuit breaker of 4A, shown with the housing;

FIG. 8 is an enlarged isometric view of the portion of the circuit breaker of FIG. 7, also showing a portion of the linear actuator assembly therefor;

FIG. 9 is an enlarged isometric view of a portion of the circuit breaker housing of FIG. 8;

FIG. 10 is an electrical schematic of a circuit breaker and linear actuator assembly therefor; in accordance with embodiments of the disclosed concept;

FIG. 11 is an isometric view of a circuit breaker and linear actuator assembly therefor, in accordance with another embodiment of the disclosed concept; and

FIG. 12 is an electrical schematic of the circuit breaker and linear actuator assembly therefor of FIG. 11.

### DESCRIPTION OF THE PREFERRED EMBODIMENTS

For purposes of illustration, embodiments of the invention will be described as applied to medium voltage circuit breakers, although it will become apparent that they could also be applied to a wide variety of electrical switching apparatus (e.g., without limitation, circuit switching devices and other circuit interrupters, such as contactors, motor starters, motor controllers and other load controllers) other than medium voltage circuit breakers and other than medium voltage electrical switching apparatus.

Directional phrases used herein, such as, for example, top, bottom, above, below, beneath and derivatives thereof, relate to the orientation of the elements shown in the drawings and are not limiting upon the claims unless expressly recited therein.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “number” shall mean one or an integer greater than one (i.e., a plurality).

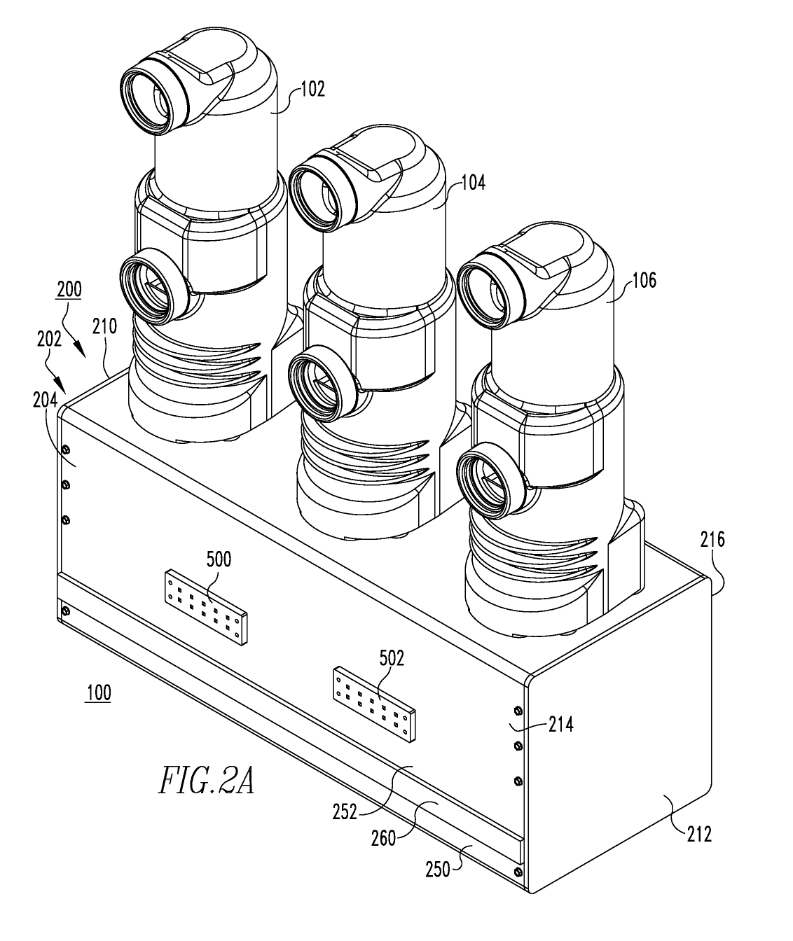

FIGS. 2A and 2B show an electrical switching apparatus, such as for example and without limitation a medium voltage circuit breaker 100, employing a linear actuator assembly 200, in accordance with the disclosed concept. The circuit breaker 100 includes a plurality of pole units 102,104,106. In the example shown and described herein, each pole unit 102,104,106 is an encapsulated pole unit (EPU) including (e.g., without limitation, enclosing) a pair of separable contacts 110 (shown in simplified view in hidden line drawing in FIG. 2B).

The linear actuator assembly 200 includes a base unit 202 having a housing 204. The housing 204 has an exterior 206 and an interior 208 (both indicated in FIG. 2B). The encapsulated pole units 102,104,106 are mounted on the exterior 206 of the housing 204 on the top (e.g., from the perspective of FIGS. 2A and 2B) of the housing 204, as shown. The housing 204 further includes a first end 210, a second end 212 disposed opposite and distal from the first end 210, and first and second opposing sides 214,216.

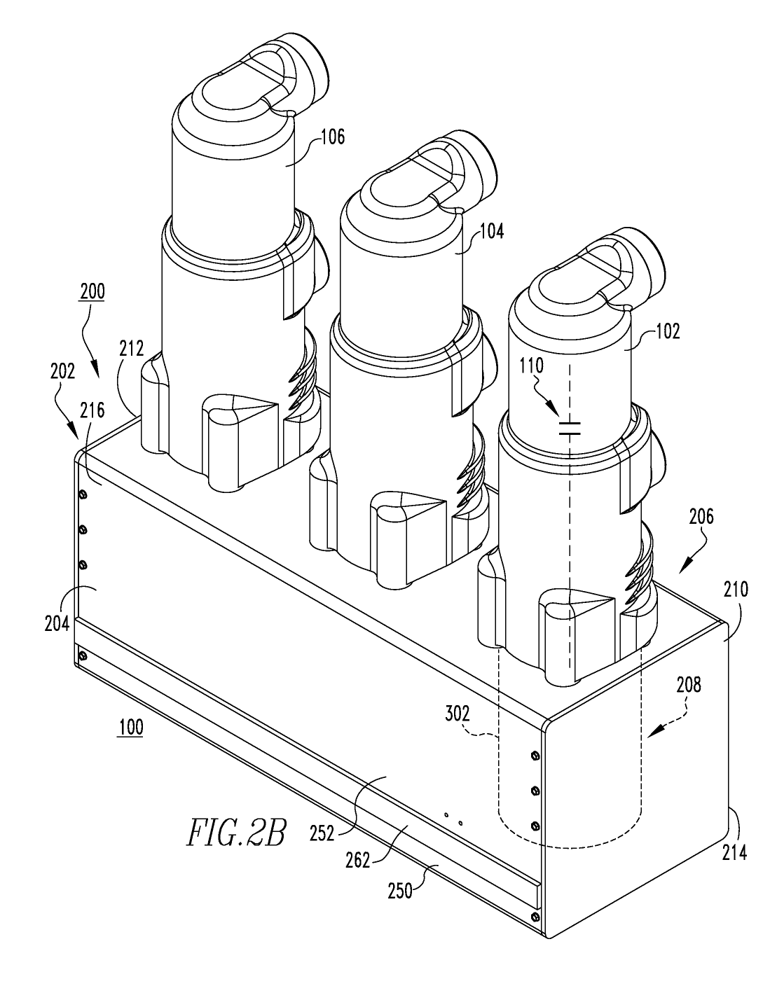

Continuing to refer to FIG. 2B, and also to FIGS. 3A and 3B, the linear actuator assembly 200 further includes a plurality of linear actuators 302,304,306 (three are shown). Each linear actuator 302,304,306 is mounted within the interior 208 of the housing 204 in alignment with a corresponding one of the pole units 102,104,106, respectively, as best shown in FIGS. 3A and 3B. Each of the linear actuators 302,304,306 is structured to actuate (e.g., without limitation, open; close; trip open) the separable contacts 110 (see, for example, separable contacts 110 of FIG. 2B) of the corresponding one of the pole units 102,104,106.

In the example shown and described herein, the linear actuators 302,304,306 are magnetic linear actuators. Furthermore, the example medium voltage circuit breaker 100 includes three pole units 102,104,106 mounted on the exterior 206 of the housing 204, and three corresponding magnetic linear actuators 302,304,306 mounted in the interior 208 of the housing, below (e.g., from the perspective of FIGS. 2B-3B) the respective pole units 102,104,106. It will be appreciated, however, that any known or suitable alternative number, type and/or configuration of linear actuators (not shown) other than the magnetic linear actuators 302,304,306 shown and described herein, could be employed without departing from the scope of the disclosed concept.

The base unit 202 of the linear actuator assembly 200 preferably further includes at least one controller 400 adapted to control actuations of the linear actuators 302,304,306. For example and without limitation, the linear actuator assembly 200 of FIGS. 2A-3B includes two electronic controllers 400,402 in electrical communication with the linear actuators 302,304,306. The example base unit 202 further includes a number of terminal blocks 500,502 for secondary power connections (not shown). The terminal blocks 500,502 are in electrical communication with the electrical controllers 400,402.

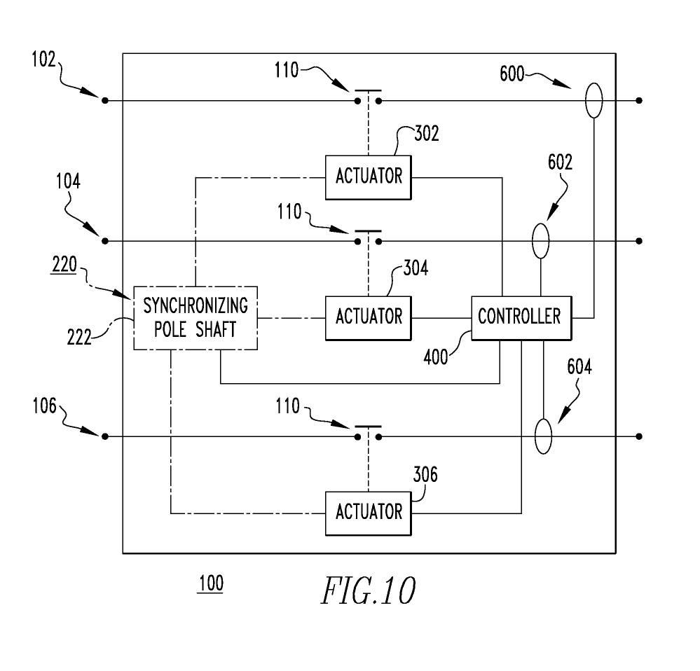

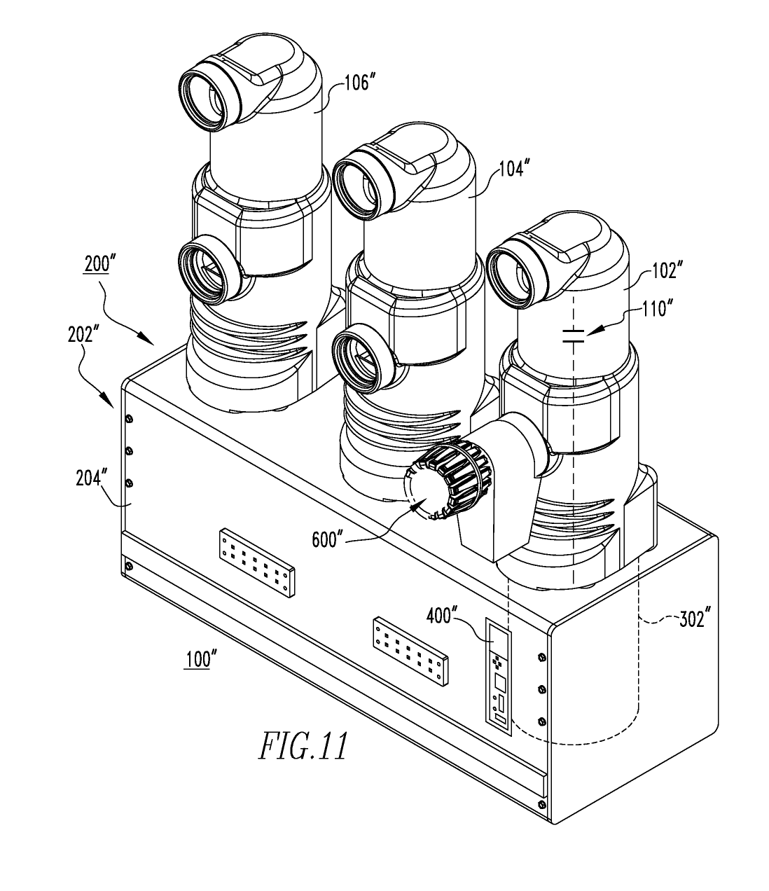

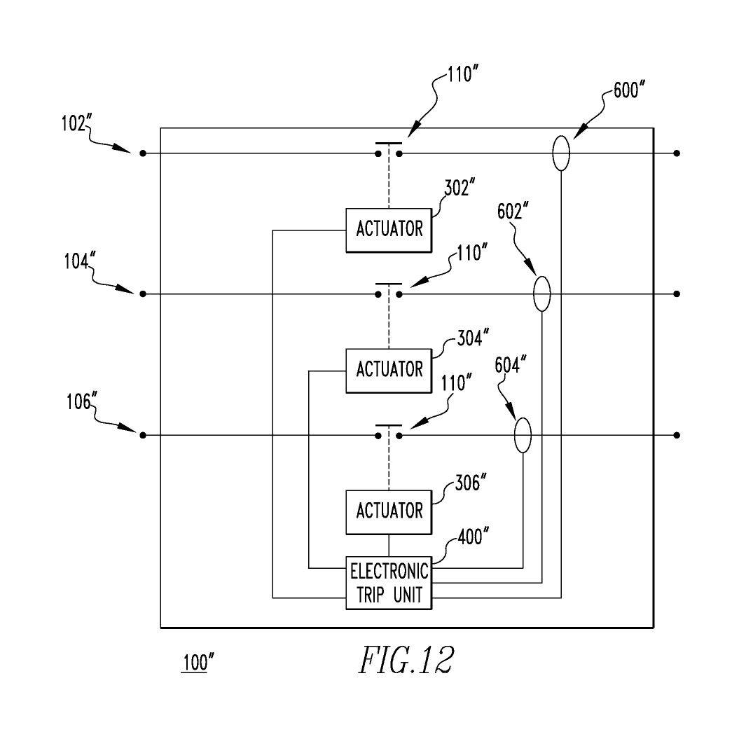

Operation of the linear actuator assembly 200 will be further appreciated with reference to the electrical schematic of FIG. 10. As shown, it will be appreciated that the base unit 202 preferably further includes a plurality of sensors 600,602,604 in electrical communication with the controller 400′. It will be appreciated that, in operation, responsive to detection of a predetermined electrical condition (e.g., without limitation, current overload; short circuit; abnormal voltage; other fault condition) by a corresponding one of the sensors 600,602,604, the controller 400 (or controllers 400,402, both shown in FIGS. 3A and 3B) actuates a corresponding at least one of the linear actuators 302,304,306. The example sensors 600,602,604 are Rogowski coils (see, also Rogowski coil 600″ of FIG. 11, and Rogowski coils 600″,602″,604″ of FIG. 12), although it will be appreciated that any known or suitable alternative number, type and/or configuration of sensors (not shown) could be employed, without departing from the scope of the disclosed concept.

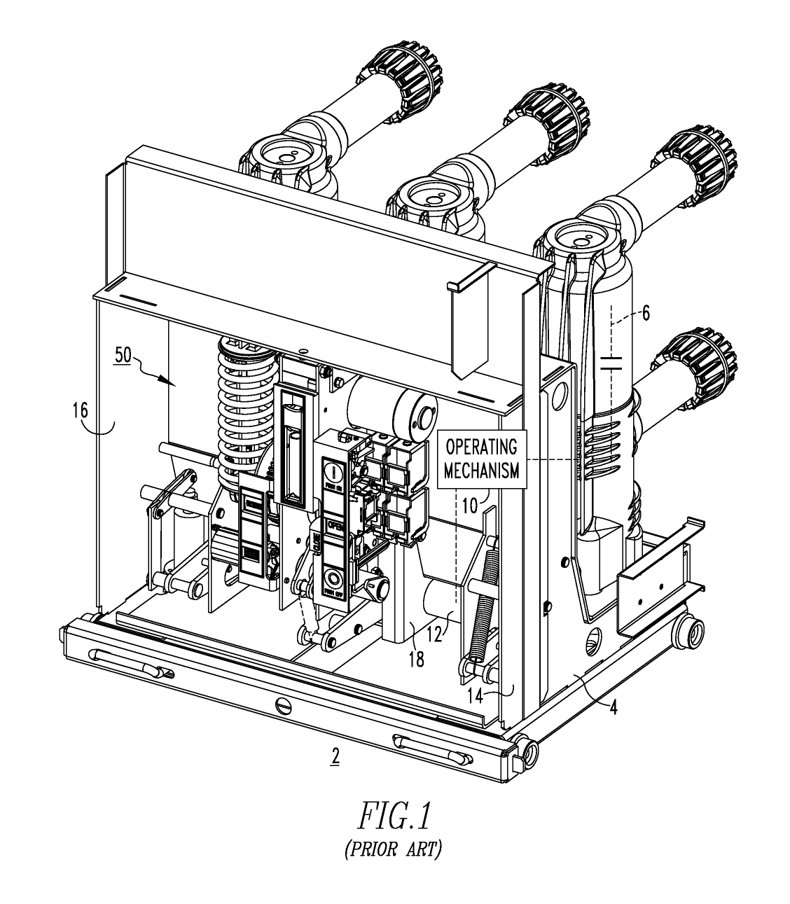

The controller(s) 400,402 is/are preferably adapted to synchronize the simultaneous actuation of all of the linear actuators 302,304,306. In other words, the disclosed circuit breaker 100 is capable of providing synchronized actuation of all of the linear actuators 302,304,306, without requiring the relatively, large complex and expensive mechanical operating mechanism and plurality of related components employed by the prior art (see, for example, FIG. 1). More specifically, the use of the linear actuators 302,304,306 and controller(s) 400,402 simplify the design, but are also substantially smaller (e.g., without limitation, 30-15 percent smaller) than previous medium voltage circuit breaker designs (see, for example, FIG. 1), thus saving substantial space and reducing weight. More specifically, the disclosed linear actuator assembly 200 provides a unique design wherein the linear actuators 302,304,306 and controller(s) 400,402 are collectively disposed within a relatively compact housing 204 of the base unit 202. Specifically, the disclosed circuit breaker 100 preferably may reduce the depth of the circuit breaker footprint by about 20-50 percent compared to prior art designs (see, for example, FIG. 1). Such significant size reduction is important, because it allows the product to be mounted in smaller switchgear and in more applications. It also results in a reduced material cost that preferably may be about 10-30 percent less compared to prior art designs (see, for example, FIG. 1), and a weight that preferably may be about 25-50 percent lower than prior art designs (see, for example, FIG. 1). Furthermore, the use of linear actuators 302,304,306 also reduces the number of mechanical moving parts, which provides the circuit breaker 100 with a longer mechanical life. For example and without limitation, the disclosed concept preferably may increase mechanical life by up to about 30,000 operations, or more. In one non-limiting example embodiment, the circuit breaker 100 may have a width of about 550 mm, a height of about 500 mm, a depth of about 150 mm, and a phase-two-phase width of about 210 mm.

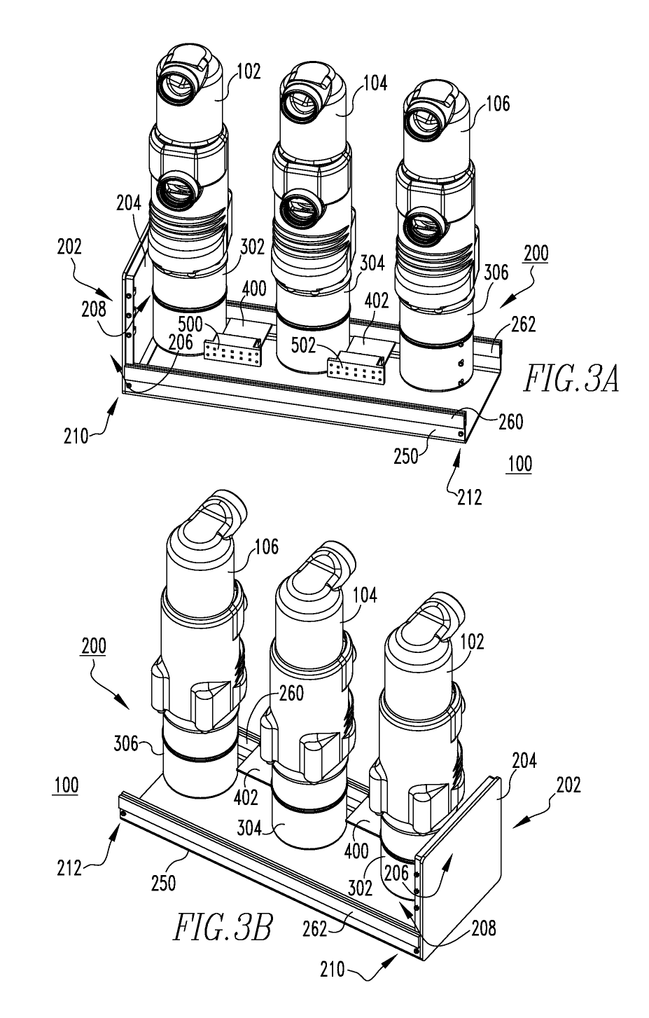

FIGS. 4A and 4B show an alternative non-limiting embodiment of a linear actuator assembly 200′ for a circuit breaker 100′, in accordance with the disclosed concept. Linear actuator assembly 200′ is substantially similar to that previously discussed hereinabove with respect to FIGS. 2A-3B, but further includes a pole shaft assembly 220. More specifically, the example circuit breaker 100′, as shown, includes three encapsulated pole units 102′,104′,106′ enclosing separable contacts 110′ (see, for example, separable contacts 110′ shown in encapsulated pole unit 102′ in simplified form in hidden line drawing in FIG. 4B). Three separate linear actuators 302′,304′,306′ are disposed beneath (e.g., from the perspective of FIGS. 4A and 4B) and substantially aligned with corresponding pole units 102′,104′,106′. The linear actuators 302′,304′,306′ are mounted within the housing 204′ of the base unit 202′ of the linear actuator assembly 200′.

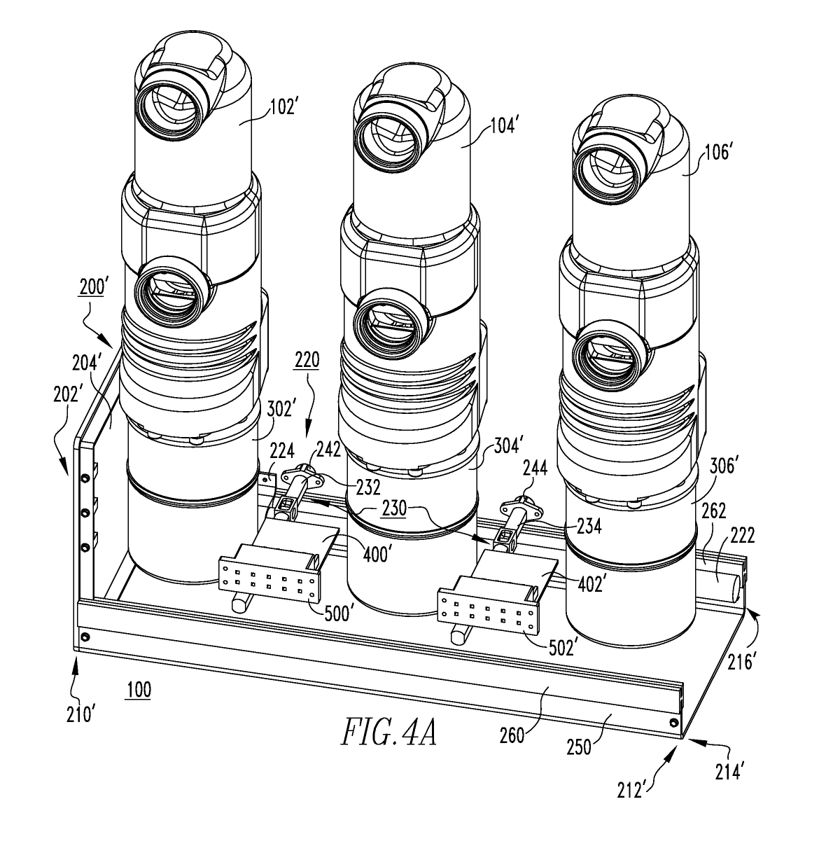

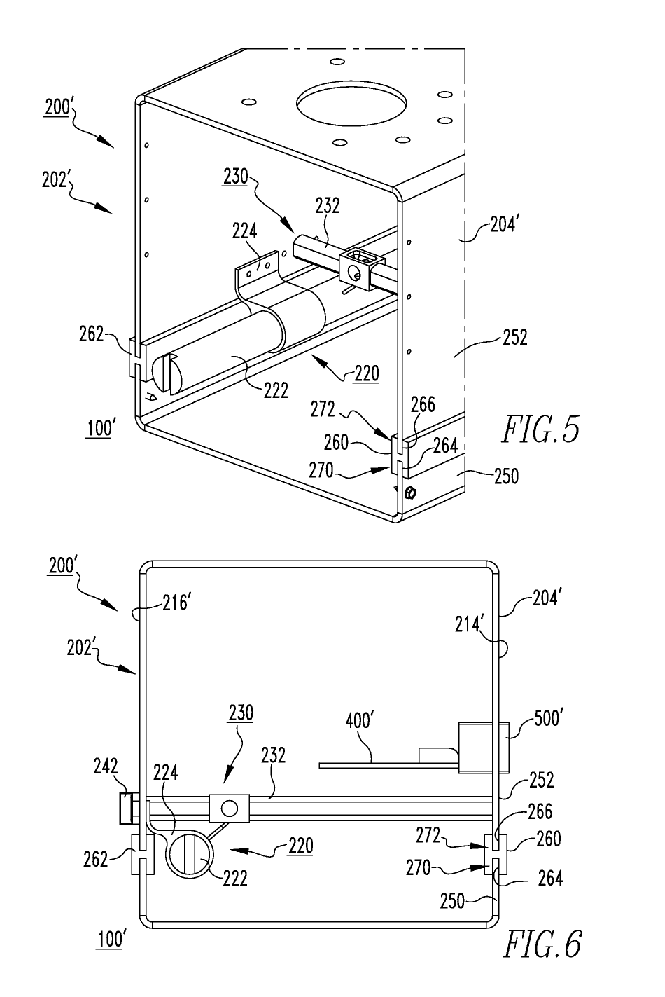

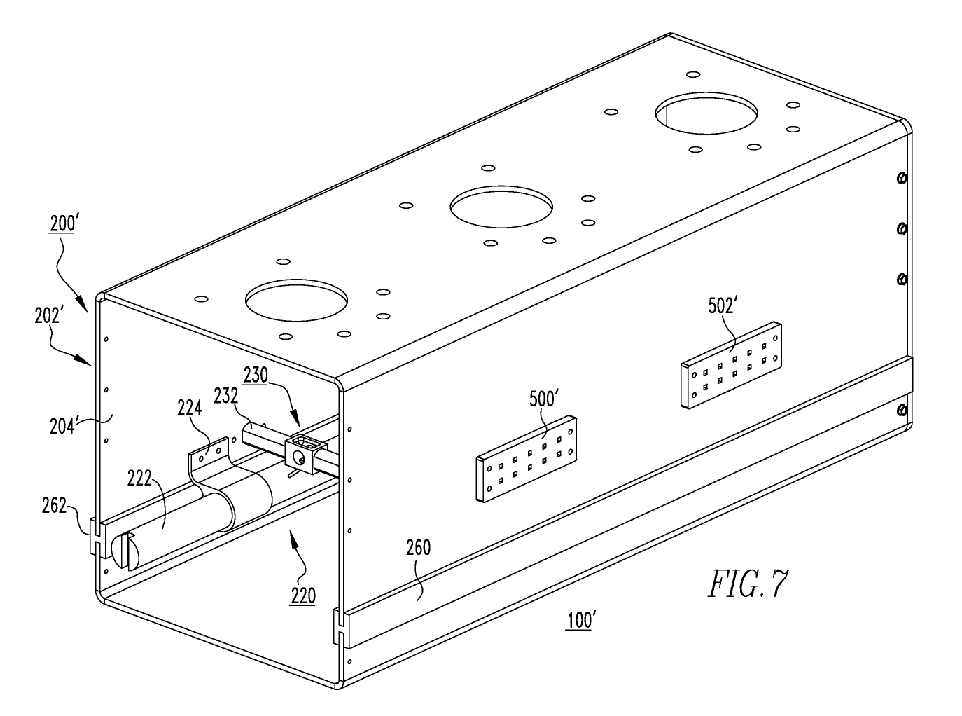

Continuing to refer to FIGS. 4A and 4B, as well as FIGS. 5-8, the pole shaft assembly 220 includes at least one pole shaft 222, a mounting bracket 224, and an interlock assembly 230. The mounting bracket 224 movably couples the pole shaft 222 to the housing 204′, as best shown in FIGS. 5-7. The interlock assembly 230 is structured to interlock the pole shaft 222 with the linear actuators 302′,304′,306′, thereby synchronizing actuation of the linear actuators 302′,304′,306′ as desired. Operation of the linear actuator assembly 200′, will be further appreciated with reference to the electrical schematic of FIG. 10, wherein the synchronizing pole shaft 222 of the pole shaft assembly 220 is indicated in simplified form in phantom line drawing.

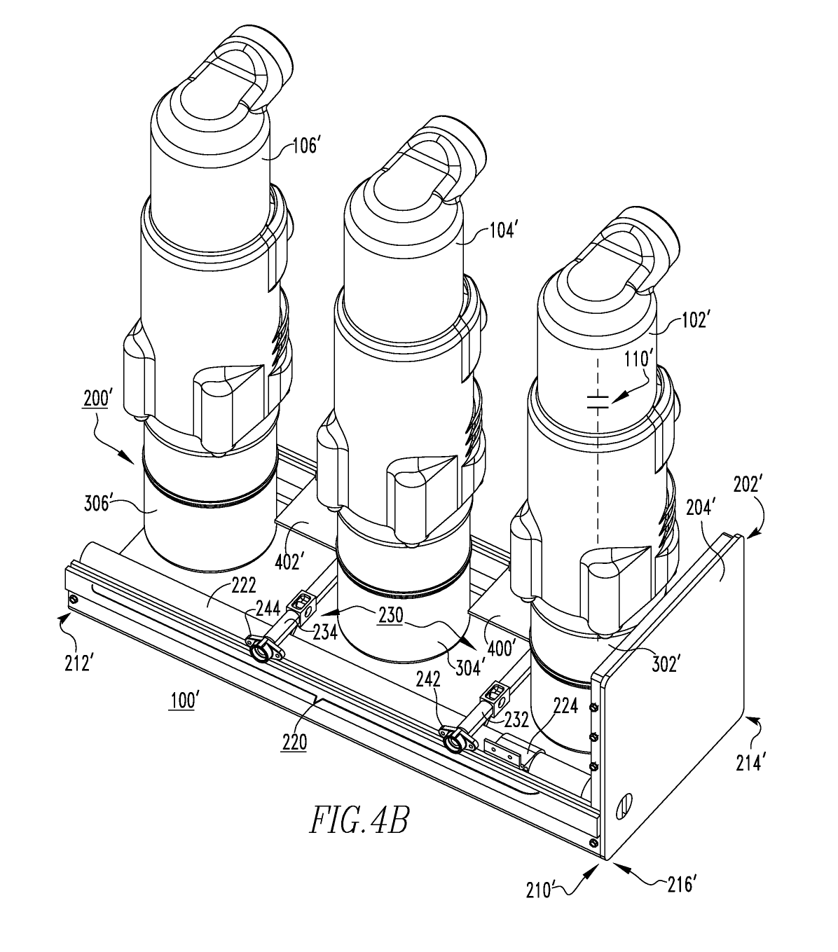

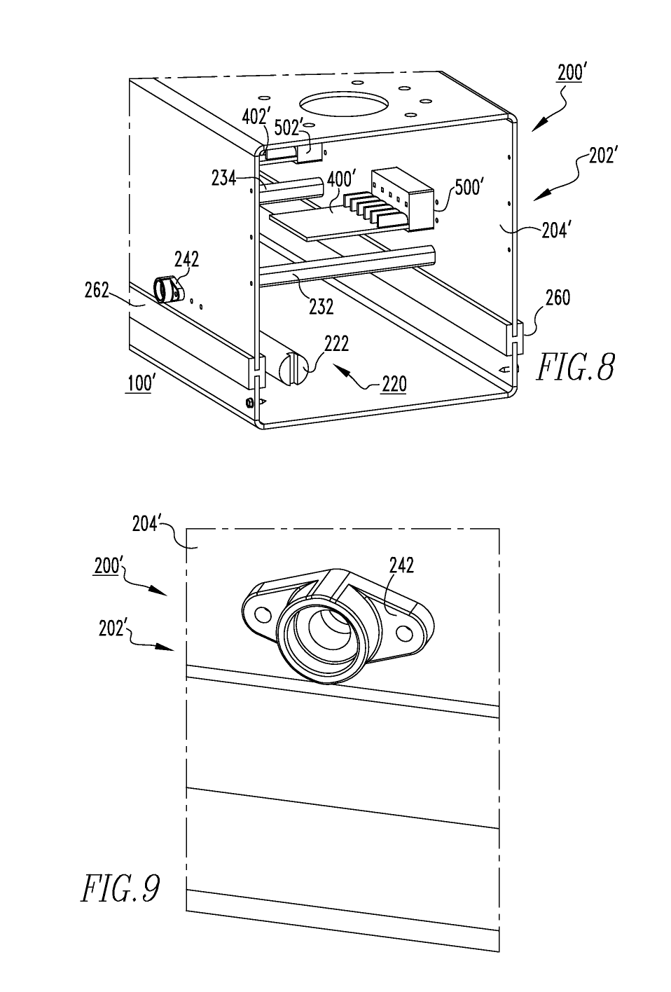

In the example of FIGS. 4A-8, the pole shaft 222 extends longitudinally between the first and second ends 210′,212′ of the base unit housing 204′. As best shown in FIGS. 4A, 4B and 6, the example interlock assembly 230 includes a plurality of interlock pins 232,234 (two are shown in FIGS. 4A and 4B), and a plurality of interlock guides 242,244 (two are shown in FIGS. 4A and 4B; see also FIG. 9). The interlock pins 232,234 extend between the first and second sides 214′,216′ of the base unit housing 204′, perpendicular with respect to the pole shaft 222. Each of the interlock guides 242,244 is structured to guide a corresponding one of the interlock pins 232,234, and each of the interlock pins 232,234 is structured to interlock with the pole shaft 222, in order to provide the aforementioned desired synchronized actuation of the linear actuators 302′,304′,306′. Such interlocking interaction will be further appreciated with reference to FIGS. 5-7, which show interlock pin 232 engaging and interlocking with pole shaft 222. FIG. 9 provides an enlarged detailed view of one of the interlock guides 242.

As best shown in the end evaluation view of FIG. 6, the housing 204′ of the base unit 202′ of the example linear actuator assembly 200′ is comprised of a plurality of sections 250,252 (two are shown) and a number of extruded brackets 260,262 (two are shown). More specifically, in the non-limiting example of FIG. 6, the housing 204′ includes a first or bottom (e.g., from the perspective of FIG. 6) section 250 and a second or top (e.g., from the perspective of FIG. 6) section 252. The first and second sections 250,252 are joined by a pair of extruded brackets 260,262, described in greater detail hereinbelow. For ease of illustration and economy of disclosure only one of the extruded brackets 260 will be described herein, in detail. It will be appreciated, however, that extruded bracket 262 is preferably substantially identical. It will further be appreciated that the housing 204′ could be alternatively comprised of any known or suitable alternative number and/or configuration of sections (not shown), other than the first and second sections 250,252, shown, and could be alternatively joined by any known or suitable alternative number, type and/or configuration of joining mechanism (not shown) other than the exemplary extruded first and second brackets 260,262. As shown in FIG. 6, the extruded bracket 260 includes first and second opposing channels 264,266, which are structured to receive and secure opposing portions 270,272 of the base unit housing 204′, in order to secure the sections 250,252 of the housing 204′ together.

FIGS. 11 and 12 show a further non-limiting embodiment of a circuit breaker 100″ and linear actuator assembly 200″ therefor, in accordance with the disclosed concept. Circuit breaker 100″ is substantially similar to circuit breakers 100 (FIGS. 2A-3B), 100′ (FIGS. 4A-9) previously discussed hereinabove, but incorporates an integral electronic trip unit 400″ and Rogowski coils 600″,602″,604″. It will be appreciated that for ease of illustration and economy of disclosure, only one Rogowski coil 600″ is shown as employed on encapsulated pole unit 102″ in the example of FIG. 11. However, any known or suitable alternative number, type and/or configuration of Rogowski coils or other suitable sensors (not shown) could be employed to communicate with the electronic trip unit 400″, or other known or suitable controller(s) (not shown) to coordinate the desired actuation (e.g., without limitation, synchronized actuation) of the linear actuators 302″,304″,306″ (all shown in simplified form in FIG. 12) to, in turn, actuate (e.g., without limitation, open; close; trip open) the separable contacts 110″ of the corresponding pole units 102″,104″,106″, in the manner previously discussed hereinabove.

Accordingly, it will be appreciate that the disclosed concept provides for an improved (e.g., without limitation, reduced cost; reduced size; lower weight; improved mechanical life) electrical switching apparatus 100,100′,100″ (e.g., without limitation, multi-pole medium voltage circuit breaker) and linear actuator assembly 200,200′,200″ therefor, which among other benefits, provides for the desired actuation (e.g., without limitation synchronized actuation) of suitable linear actuators 302′,304′,306′,302″,304″,306″ for the respective pole units 102,104,106,102′,104′,106′,102″,104″,106″ of the circuit breaker 100,100′,100″.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A linear actuator assembly for an electrical switching apparatus, said electrical switching apparatus comprising a plurality of pole units each including separable contacts, said linear actuator assembly comprising:
a base unit comprising a housing; and
a plurality of linear actuators each being structured to be mounted within the housing in alignment with a corresponding one of said pole units,
wherein each of said linear actuators is structured to actuate the separable contacts of said corresponding one of said pole units.

2. The linear actuator assembly of claim 1 wherein said plurality of linear actuators is a plurality of magnetic linear actuators.

3. The linear actuator assembly of claim 2 wherein the housing includes an exterior and an interior; wherein said plurality of pole units is three pole units mounted on the exterior; and wherein said plurality of linear actuators is three magnetic linear actuators mounted in the interior.

4. The linear actuator assembly of claim 1 wherein said base unit further comprises a controller adapted to control actuation of said linear actuators.

5. The linear actuator assembly of claim 4 wherein said base unit further comprises a number of terminal blocks.

6. The linear actuator assembly of claim 4 wherein said base unit further comprises a plurality of sensors in electrical communication with said controller; and wherein, responsive to detection of a predetermined electrical condition by a corresponding one of said sensors, said controller actuates at least one of said linear actuators.

7. The linear actuator assembly of claim 6 wherein said controller is adapted to synchronize the simultaneous actuation of all of said linear actuators.

8. The linear actuator assembly of claim 6 wherein said base unit further comprises a pole shaft assembly including a pole shaft, a mounting bracket, and an interlock assembly; wherein said mounting bracket movably couples said pole shaft to the housing; and wherein said interlock assembly is structured to interlock said pole shaft with said plurality of linear actuators, thereby synchronizing actuation of said linear actuators.

9. The linear actuator assembly of claim 8 wherein the housing includes a first end, a second end disposed opposite and distal from the first end, a first side, and a second side disposed opposite the first side; wherein said pole shaft extends longitudinally between the first end and the second end; wherein said interlock assembly comprises a plurality of interlock pins and a plurality of interlock guides; wherein said interlock pins extend between the first side and the second side, perpendicular with respect to said pole shaft; wherein each of said interlock guides is structured to guide a corresponding one of said interlock pins; and wherein each of said interlock pins is structured to interlock with said pole shaft to provide synchronized actuation of said plurality of linear actuators.

10. The linear actuator assembly of claim 6 wherein said controller comprises an electronic trip unit; and wherein said sensors are Rogowski coils.

11. The linear actuator assembly of claim 1 wherein the housing includes a plurality of sections and a number of extruded brackets; wherein each of said number of extruded brackets includes a first channel and a second channel disposed opposite said first channel; and wherein said first channel and said second channel each receive a corresponding portion of the housing to secure said sections of the housing together.

12. An electrical switching apparatus comprising:
a plurality of pole units each including separable contacts; and
a linear actuator assembly comprising:
a base unit comprising a housing, and
a plurality of linear actuators each being mounted within the housing in alignment with a corresponding one of said pole units,
wherein each of said linear actuators is structured to actuate the separable contacts of said corresponding one of said pole units.

13. The electrical switching apparatus of claim 12 wherein said base unit further comprises a controller and a plurality of sensors in electrical communication with said controller; and wherein, responsive to detection of a predetermined electrical condition by a corresponding one of said sensors, said controller actuates at least one of said linear actuators.

14. The electrical switching apparatus of claim 13 wherein said base unit further comprises a number of terminal blocks.

15. The electrical switching apparatus of claim 13 wherein said controller is adapted to synchronize simultaneous actuation of all of said linear actuators.

16. The electrical switching apparatus of claim 13 wherein said base unit further comprises a pole shaft assembly including a pole shaft, a mounting bracket, and an interlock assembly; wherein said mounting bracket movably couples said pole shaft to the housing; and wherein said interlock assembly interlocks said pole shaft with said plurality of linear actuators, thereby synchronizing actuation of said linear actuators.

17. The electrical switching apparatus of claim 16 wherein the housing includes a first end, a second end disposed opposite and distal from the first end, a first side, and a second side disposed opposite the first side; wherein said pole shaft extends longitudinally between the first end and the second end; wherein said interlock assembly comprises a plurality of interlock pins and a plurality of interlock guides; wherein said interlock pins extend between the first side and the second side, perpendicular with respect to said pole shaft; wherein each of said interlock guides is structured to guide a corresponding one of said interlock pins; and wherein each of said interlock pins is structured to interlock with said pole shaft to provide said synchronized actuation of said plurality of linear actuators.

18. The electrical switching apparatus of claim 13 wherein said controller comprises an electronic trip unit; and wherein said sensors are Rogowski coils.

19. The electrical switching apparatus of claim 12 wherein the housing includes a plurality of sections and a number of extruded brackets; wherein each of said number of extruded brackets includes a first channel and a second channel disposed opposite said first channel; and wherein said first channel and said second channel each receive a corresponding portion of the housing to secure said sections of the housing together.

20. The electrical switching apparatus of claim 12 wherein said electrical switching apparatus is a three pole circuit breaker; wherein the housing includes an exterior and an interior; wherein said plurality of pole units is three encapsulated pole units mounted on the exterior; and wherein said plurality of linear actuators is three magnetic linear actuators mounted in the interior.
